(19) United States
(12) Patent Application Publication
(10) Pub. No.: US 2026/0228745 A1
(43) Pub. Date: Aug. 6, 2026

(54) TRANSACTION AUTHORIZATION ROUTE OPTIMIZATION

(71) Applicant: MASTERCARD INTERNATIONAL INCORPORATED, Purchase, NY (US)

(72) Inventors: Balamurali Balasubramanian, Chennai (IN); Vikas Chandra, Pune (IN)

(21) Appl. No.: 19/044,166

(22) Filed: Feb. 3, 2025

(51) Int. Cl. G06Q 20/42; G06Q 20/40

(52) U.S. Cl. CPC G06Q 20/425; G06Q 20/4014

(57) ABSTRACT

Systems and methods for transaction authorization routing can include receiving, at a payment network, a transaction request for a transaction on behalf of a cardholder, wherein the transaction request includes a time of the transaction; determining, by the payment network, a recommended transaction approval system from a plurality of available options based on a primary issuer identified from the transaction request, wherein the plurality of available options includes at least two possible transaction approval systems, wherein the recommended transaction approval system is based on historical processing with respect to the primary issuer and features extracted from the transaction request, including at least the time of the transaction; and sending an authorization request for the transaction to the recommended transaction approval system.

### BACKGROUND

Traditionally, during a transaction process flow for payment card transactions, the primary issuer of the payment card is responsible for authorization/preauthorization for transactions involving that payment card. During this transaction process flow, one of the main roles of a payment network is to route the authorization request for a transaction to the primary issuer associated with a particular payment card used in the transaction.

However, there are several circumstances where systems other than the primary issuer perform authorization/preauthorization for the transaction, for example, when the primary issuer is unavailable or unresponsive. Currently, authorization request routing performed by the payment networks involves first sending the authorization request to the primary issuer, then, if the primary issuer is unavailable, the payment network may proceed down a list of alternate transaction approval systems to find an alternate transaction approval system that can perform the authorization/preauthorization. This corrective process results in numerous messages being sent and is an inefficient use of computing power and resources, since the transaction may not be authorized on the first attempt.

Therefore, systems and methods for optimizing authorization request routes are desired.

### BRIEF SUMMARY

Systems and methods for optimizing transaction authorization routing are described. The payment network, via a routing recommendation system, can determine a recommended transaction approval system for sending an authorization request most likely to be available to perform the authorization/preauthorization.

In some aspects, the techniques described herein relate to a method, including: receiving, at a payment network, a transaction request for a transaction on behalf of a cardholder, wherein the transaction request includes a time of the transaction; determining, by the payment network, a recommended transaction approval system from a plurality of available options based on a primary issuer identified from the transaction request, wherein the plurality of available options includes at least two possible transaction approval systems, wherein the recommended transaction approval system is based on historical processing with respect to the primary issuer and features extracted from the transaction request, including at least the time of the transaction; and sending an authorization request for the transaction to the recommended transaction approval system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example conventional payment card process.

FIG. 2A illustrates an example payment card process with an alternate transaction approval system.

FIG. 2B illustrates an example operating environment for routing transactions.

FIGS. 3A-3B illustrate an example process for routing an authorization request to a transaction approval system.

FIG. 4A illustrates an example routing recommendation system.

FIG. 4B illustrates example data dictionary for training models.

FIG. 5 illustrates components of a computing system that may be used to implement certain methods and services described herein.

### DETAILED DESCRIPTION

Systems and methods for optimizing transaction authorization routing are described. The payment network, via a routing recommendation system, can determine a recommended transaction approval system for sending an authorization request most likely to be available to perform the authorization/preauthorization. In some cases, the first recommended transaction approval system for sending the authorization request is not automatically the primary issuer.

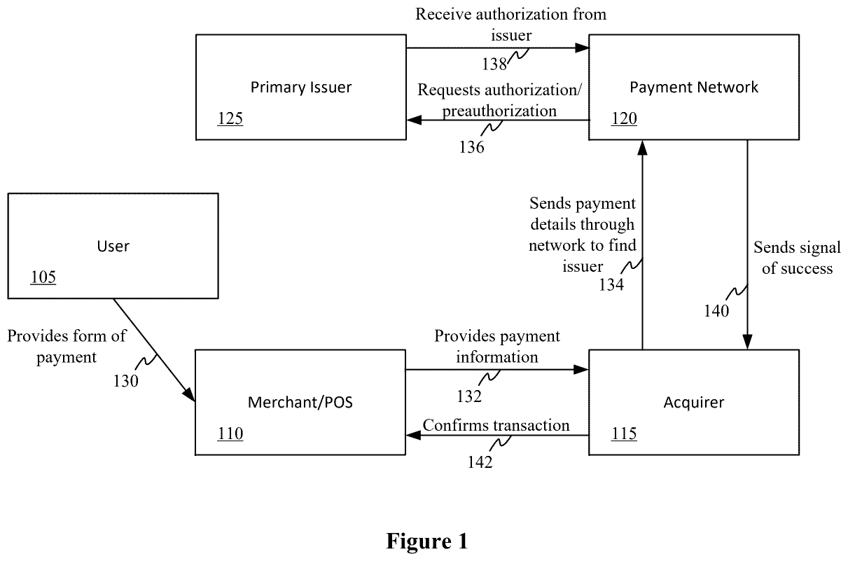

FIG. 1 illustrates an example conventional payment card process. Referring to FIG. 1, in conventional payment card processes, there is communication between a user 105, merchant 110, an acquirer 115, a payment network 120, and a primary issuer 125. The conventional payment process includes payment card authorization, clearing, and settlement. The user 105 can be the cardholder or a person authorized to use the account corresponding to the cardholder. The merchant 110 can be a provider of goods or services in exchange for payment. The merchant 110 can be physically present at a sale (e.g., as a point-of-sale terminal) or remote, such as an online retailer. The acquirer 115 can be a party that receives funds on behalf of the merchant 110 in a payment card transaction. The acquirer 115 can be a bank or other institution associated with the merchant 110. The payment network 120 facilitates transactions between merchants (e.g., merchant 110) and payment card issuers (e.g., primary issuer 125). Examples of payment network 120 include the Mastercard payment network and the Visa payment network. A primary issuer 125 can be a bank or other institution at which a user has an account and which issues the payment card to the user.

A process of payment card authorization can begin with a user 105 presenting a form of payment to purchase goods or services as shown in flow (130). In some cases, the form of payment can be a physical card or a contactless card (e.g., hosted on a mobile device, and available on an e-wallet).

The merchant 110 can extract information about the form of payment such as the credit card number, confirmation code, and expiration date. Information obtained by the merchant 110 can also include information about the purchase, such as location, amount, goods type, and a form of verification provided.

A transaction request, comprising at least the information about the form of payment and the information about the purchase, can be provided to an acquirer 115 associated with the merchant 110 as shown at flow (132). The acquirer 115 can, in turn, provide the transaction request to the payment network 120 as shown at flow (134).

The payment network 120 can identify an issuing bank, or primary issuer 125, of the user's form of payment. The transaction can be logged to aid in later processes, such as clearing and settlement. Certain details of the transaction can also be stored in a transaction information storage, which may be associated with the payment network 120. It should be understood that storage of transaction information is performed under appropriate privacy and security policies (and any applicable laws). When the payment network 120 identifies the primary issuer 125, the payment network 120 can send the transaction request (e.g., authorization request) requesting authorization and/or preauthorization on the form of payment from the primary issuer 125, as shown at flow (136).

The primary issuer 125 can run the requested authorization or preauthorization. Authorization can entail ensuring that a transaction is legitimate, such as by checking the provided verification, location, and amount. After one or more of these checks are performed, the primary issuer 125 can accept the transaction and forward an authorization result indicating success or failure back to the payment network 120 as shown at flow (138).

The payment network 120 can forward the authorization result to the acquirer 115 as shown at flow (140). The acquirer can then forward the authorization result back to the merchant 110 as shown at step (142) to confirm that the transaction has been authorized. Later on, settlement and clearing can occur. In clearing, the payment and transaction information can be double checked for accuracy. In settlement, the primary issuer 125 can transfer funds to the payment network 120; the payment network 120 can then transfer the funds to the acquirer 115. Once the acquirer 115 receives the funds, the funds can be made available to the merchant 110.

During the transaction processing flow for card payments (e.g., credit card or debit card), one of the primary roles of a payment network is to ensure that a transaction (e.g., an authorization request for the transaction) is properly routed to the primary issuer 125. In many cases, this can include identifying the primary issuer (e.g., primary issuer 125) associated with a particular payment card.

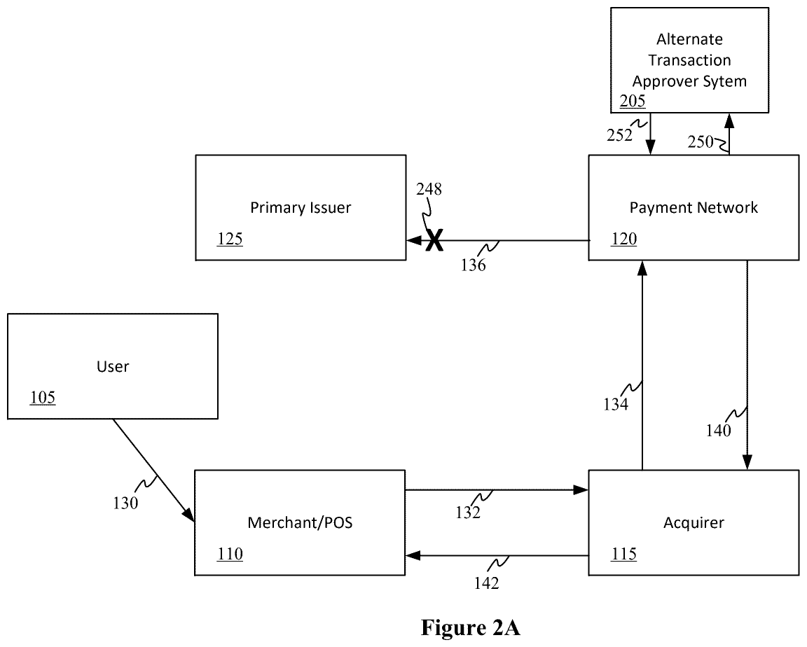

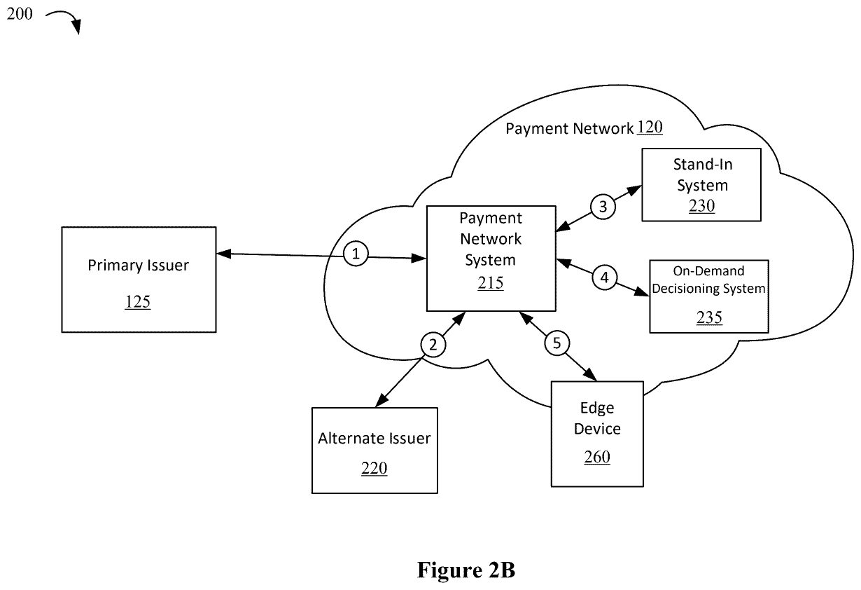

However, as illustrated in FIGS. 2A-2B, in scenarios where the primary issuer 125 is unavailable, the payment network 120 must route the authorization request to an alternative transaction approval system.

FIG. 2A illustrate a scenario for a payment card process with an alternate transaction approval system. Referring to FIG. 2A, processes including flows (130)-(136) can be performed as described with respect to FIG. 1. However, in the scenario shown in FIG. 2A, there is a problem (248) with the communication with the primary issuer 125. Here, the primary issuer 125 fails to send a signal indicating receipt of the authorization request to the payment network 120 or fails to send an authorization result indicating success or failure back to the payment network 120. In some cases, the failure of the communication may be due to the primary issuer 125 experiencing difficulties (e.g., network outages, power outage, etc.). Based on the failure of the communication between the payment network 120 and the primary issuer 125, the payment network 120 determines that the primary issuer 125 is unavailable and cannot perform authorization and/or preauthorization.

In cases where the primary issuer 125 fails to respond and/or there is an indication that the primary issuer 125 is unavailable, the payment network 120 can then direct a authorization/preauthorization request to approve or deny the transaction to an alternate transaction approval system 205, as shown in (250). The alternate transaction approval system 205 can send an authorization signal, as shown at flow (252), to approve or deny the transaction on behalf of a primary issuer (e.g., primary issuer 125) when the issuer is unavailable. Flows (140) and (142) can be as described in FIG. 1.

A transaction approval system is a system with authority to perform authorization/preauthorization for a transaction. For example, the alternate transaction approval system 205 may be a stand-in system. In the illustrated scenario, it can be seen that the payment network first sent the authorization request message to the primary issuer 125 and when communication failed (e.g., by lack of response or some other indication of network issues), the payment network sends the authorization request message to alternate transaction approval system 205. It is possible for there to be more than one type of alternate transaction approval system and, as mentioned briefly above, the payment network typically follows a set order for when to communicate with a particular alternate transaction approval system. An example of a communication order with various transaction approval systems is described with respect to FIG. 2B.

FIG. 2B illustrates an example operating environment for routing transactions. Referring to FIG. 2B, in the example operating environment 200, four alternate transaction approval systems 205 are shown. Here, stand-in system 230, on-demand decisioning system 235, and edge device 260 can be available on the payment network itself and an alternate issuer 220 can be named to carry out operations on behalf of the primary issuer 125.

Referring to FIGS. 2A-2B, when the payment network 120 receives a transaction request for a transaction, as shown at flow (134), a payment network system 215 on the payment network 120 routes the authorization request requesting transaction authorization to an appropriate transaction approval system.

As illustrated by the numerated pathways in FIG. 2B, there can be a plurality of options for transaction approval systems that a payment network 120 can send the authorization request to. However, as described with respect to FIG. 1 and FIG. 2A, the payment network 120 follows a sequential authorization flow, and first attempts to send the authorization request to the primary issuer 125.

Then, if the primary issuer 125 fails to respond, the payment network 120 can sequentially move down a list of alternative transaction approval systems (e.g., alternate issuer 220, stand-in system 230, etc.) until authorization is complete (e.g., receive signal of authorization success/failure).

For example, in some cases, if the primary issuer 125 fails to respond to the authorization request, the payment network 120 can send the authorization request to the alternate issuer 220. An alternate issuer 220 is an issuer that has an agreement with the primary issuer 125, such that when the primary issuer 125 is unavailable, the alternate issuer 220 can authorize a transaction on behalf of the primary issuer 125.

In some cases, if the primary issuer 125 fails to respond to the authorization request, the payment network 120 can send the authorization request to a stand-in system 230. The stand-in system 230 can approve or deny the transaction on behalf of an issuer (e.g., primary issuer 125) when the issuer is unavailable. The stand-in system 230 is a backup or temporary system that performs transaction processing when the primary issuer 125 is unavailable or offline. In some cases, the stand-in system 230 is a system on the payment network 120.

In some cases, if the primary issuer 125 fails to respond to the authorization request, the payment network 120 can send the authorization request to an on-demand decisioning system 235. The on-demand decisioning system 235 can approve or deny the transaction on behalf of an issuer (e.g., primary issuer 125), even in cases when the issuer is available. The on-demand decisioning system 235 is a system on the payment network 120 that can perform transaction processing based on rules set up with the primary issuer 125. For example, the issuer 125 may prefer that low value transactions (e.g., less than $100) and low risk transactions are authorized by the on-demand decisioning system 235, to help reduce traffic to the primary issuer 125. In some cases, the on-demand decisioning system 235 is a system on the payment network 120. In some cases, the on-demand decisioning system 235 can be used in place of or in addition to the stand-in system 230.

In some cases, if the primary issuer 125 fails to respond to the authorization request (and the stand-in system 230 and/or on-demand decisioning system 235) fail to respond to the authorization request, the payment network 120 can send the authorization request to the edge device 260 on the payment network 120. In some cases, the edge device 260 is a hardware component on the payment network 120 that can act as a network endpoint (e.g., entry or exit point), between two networks (e.g., payment network 120 and a different network). The edge device 260 can perform X-code processing based on primary issuer 125 rule configurations to authorize a transaction. In some cases, the processes performed by the edge device 260 are a more simplistic and less resource intensive form of authorization than that performed by the stand-in system 230.

The following example is a conventional process flow with steps for routing an authorization request for a particular transaction:
1. Send the authorization request to the primary issuer 125.
2A. If there is no response from the primary issuer 125, and the primary issuer 125 has opted for alternate issuer 220 for authorization, send the authorization request to the alternate issuer 220.
2B. If there is no response from the primary issuer 125, and the primary issuer 125 has opted for stand-in processing, send the authorization request to the stand-in system 230.
3. If there is no response after 2A or 2B (e.g., from the alternate issuer 220 or the stand-in system 230), send the authorization request to the edge device 260.

Similar sequential process flows like the example above are commonly used by payment networks when routing authorization requests. However, these corrective, sequential processes rely on trial and error (e.g., sending the authorization request to a primary issuer 125 and waiting for a response, or lack of response, before proceeding to send the authorization request to the next transaction approval system). Automatically routing the authorization request first to the primary issuer is an inefficient and wasteful use of computing resources because messages are unnecessarily sent, even in scenarios where it could have been possible to predict and account for the primary issuer's failure to respond (such as where a request was just made that failed or where there is a known network outage).

Advantageously, as described herein, a payment network 120 can be provided with a routing recommendation system to determine which transaction approval system, out of a plurality of options, for a particular incoming transaction request based on historical data and features extracted from the transaction request to increase successful authorization on the first attempt.

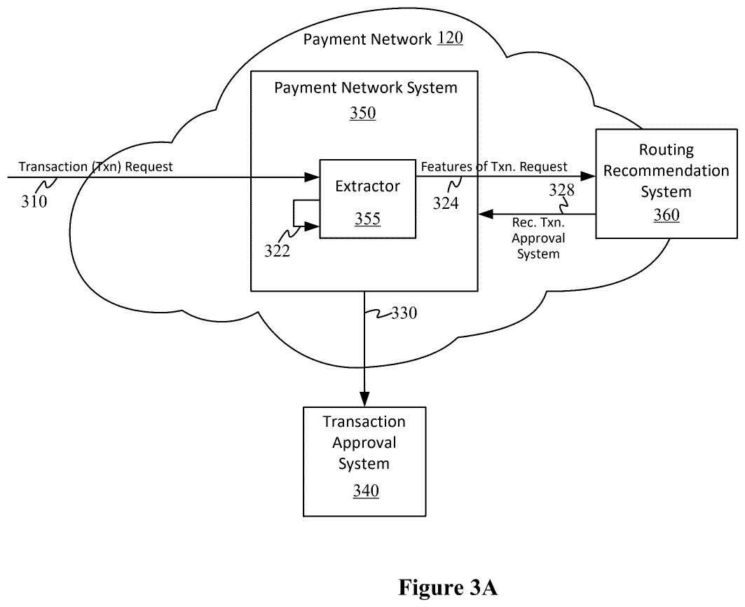

FIG. 3A illustrates an example implementation of a payment network with a routing recommendation system and FIG. 3B illustrates a process flow diagram for routing an authorization request to a transaction approval system. Referring to FIG. 3A, payment network 120 can include a routing recommendation system 360 which can be part of or in communication with a payment network system 350. Payment network system 350 includes an extractor 355 which may be embodied as instructions that are executed by one or more processors of the payment network system 350.

Referring to FIGS. 3A-3B, a process 300 for routing an authorization request to a transaction approval system can begin when a payment network system 350 receives (310) a transaction request for a transaction on behalf of a cardholder. The transaction request can include a time of the transaction. In response to receiving the transaction request, the payment network system 350 can determine (320) a recommended transaction approval system from a plurality of available options. The plurality of available options can be based on a primary issuer identified from the transaction request and can include at least two possible transaction approval systems (e.g., the primary issuer and an alternate transaction approval system or at least two alternate transaction approval systems). The recommended transaction approval system can be determined based on historical processing with respect to the primary issuer and features extracted from the transaction request, including at least the time of the transaction. Once a recommended transaction approval system is determined, the payment network system 350 can send (330) the authorization request for the transaction to the recommended transaction approval system (e.g., transaction approval system 340).

Advantageously, the recommended transaction approval system is not automatically the primary issuer. By determining a recommended transaction approval system on a transaction-by-transaction basis, the payment network can reduce unnecessary waste of computer resources, decrease unnecessary network traffic, and improve transaction turnaround time by identifying the most optimal possible route for the authorization request.

The transaction request received (310) by the payment network system 350 can include transaction information, such as, but not limited to, a payment card number, a time of the transaction, a date of the transaction, a transaction total, a merchant identifier, a merchant location, and a transaction type code. Advantageously, because the transaction information included for each transaction request is particular to the transaction, the payment network system 350 (e.g., via the routing recommendation system 360) can utilize the individual and unique aspects of the transaction request in making the determination for a recommended transaction approval system.

For example, to determine (320) a transaction approval system to send the authorization request to, the payment network system 350 extracts (322) features of the transaction request, for example via the extractor 355, and inputs (324) the extracted features to a routing recommendation system 360 that predicts (326) a transaction approval system based on the extracted features and outputs (328) the transaction approval system to the payment network system 350.

The extractor 355 can extract (322) features of the transaction request to be used as inputs for the routing recommendation system 360. For example, extracted features may include, but are not limited to, time of transaction, date of transaction, transaction total, transaction type code, issuer identifier, issuer country, issuer region, merchant identifier, merchant country, and merchant region.

In some cases, extracting (322) features involves extracting features directly from the transaction request. Certain information included in the transaction request can be readily extractable and parsed directly from the transaction request and formatted to be input to the routing recommendation system 360. For example, transaction total, a time of the transaction, a date of the transaction, a transaction type code, and transaction currency may be features that can be extracted from the transaction request.

In some cases, extracting (322) features can include additional processing steps. Certain information included in the transaction request may require additional steps to obtain a particular feature to be used as an input for the routing recommendation system 360. For example, an issuer identifier may not be directly extractable from the transaction request, as issuer identifier is not typically a field included in the transaction request. However, the extractor 355 may use information included in the transaction request (e.g., payment card number) to perform a look-up for an issuer identifier associated with the transaction.

In some cases, an issuer identifier of the primary issuer (or a similar indication of primary issuer associated with the transaction) may be a useful feature to input to the routing recommendation system 360 because the primary issuer can influence the plurality of available transaction approval system options. For example, different primary issuers can have different rules, requirements, and permissions regarding transaction approval systems that are authorized to perform authorization on behalf of the primary issuer.

For example, Issuer A may be the primary issuer for a particular payment card associated with a transaction. Issuer A may have an agreement with Issuer B for Issuer B to be an alternate issuer. Additionally, Issuer A may be set up to utilize an on-demand decisioning system (instead of the stand-in system). Therefore, the plurality of available options for Issuer A may be different from Issuer C, who may not have an alternate issuer, and may have opted in to the stand-in system, but not the on-demand decisioning system.

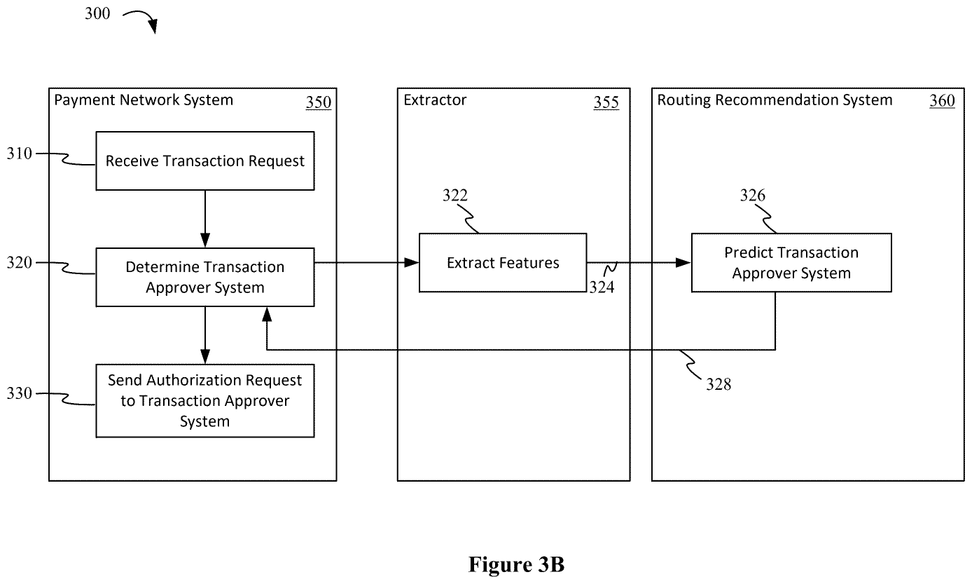

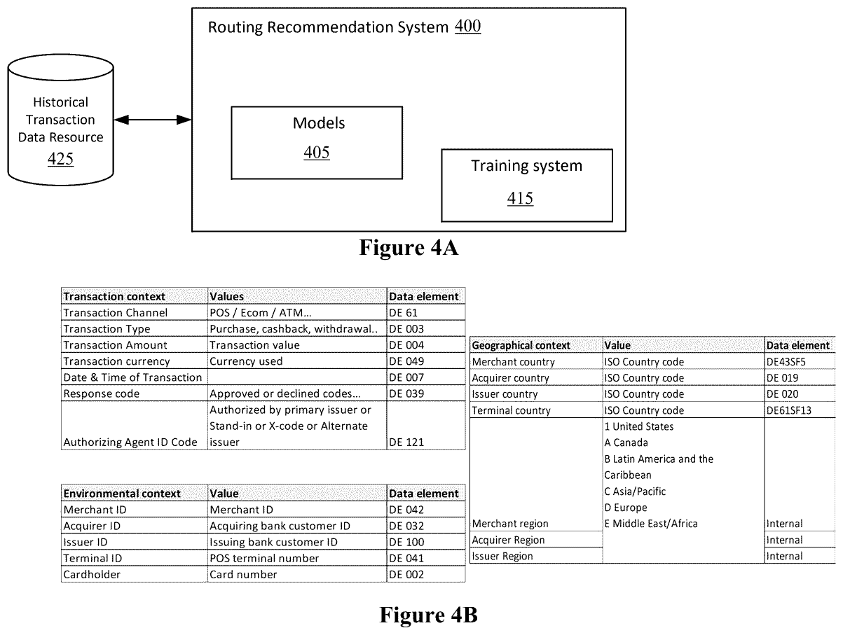

Once the extractor 355 has extracted (322) the features to be input to the routing recommendation system 360, the extracted features are provided to the routing recommendation system 360, as shown at flow (324). An example routing recommendation system is described in more detail with respect to FIG. 4A.

FIG. 4A illustrates an example routing recommendation system.

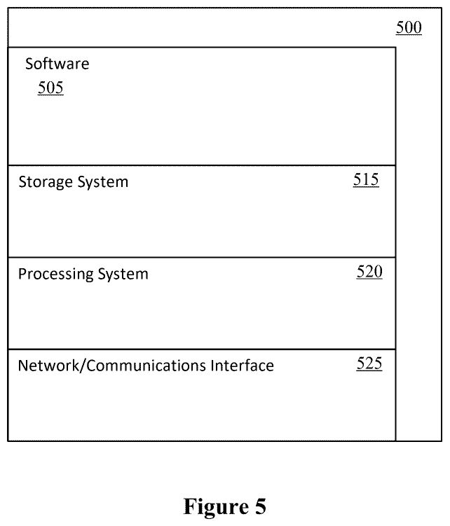

Referring to FIG. 4A, the routing recommendation system 400 can be a machine learning system. The machine learning system may be embodied by a computing device, a server, a cloud computing environment, and/or the like, a representation of which is shown in FIG. 5.

The routing recommendation system 400 can include models 405 that are used by the routing recommendation system 400 to predict the most likely available transaction approval system. The models 405 can be stored at the routing recommendation system 400 and used by the routing recommendation system 400 to predict a recommended transaction approval system. The models 405 can include a set of weights generated by a training system 415 performing training using training data such as available from historical transaction data resource 425. Training system 415 can support supervised and unsupervised machine learning algorithms. In some cases, the models are neural network models. The models 405 can be built using historical transaction data, including historical processing behaviors of issuers, and updated as additional transactions take place. In some cases, the training data can include historical data of network reliability and completed communication requests between the payment network and issuers. For security and privacy purposes, the historical transaction data may not include cardholder specific information.

The models 405 can include models built using a collaborative filtering algorithm and/or content-based filtering algorithm. In some cases, the routing recommendation system 400 uses both collaborative filtering and content-based filtering models to predict the recommended transaction approval system (e.g., hybrid recommendation).

FIG. 4B illustrates example data dictionary of data used for training models 405. The data dictionary can be generated from transaction data during pre-processing stages. In some cases, the data dictionary can segment historical transaction data based on context. In some cases, the historical transaction data can be segmented by context, for example, transaction context, environmental context, and geographical context. The data dictionary can be used for feature engineering and model creation. In some cases, feature engineering can include computing a similarity score for the historical transaction data. For example, the training system 415 of routing recommendation system 400 can calculate the similarity indices between each pair of transactions and authorization system which proceeded the record and return a 2-D array.

Transaction context can include features associated with the particular transaction, for example, time of transaction, date of the transaction, transaction type, transaction amount. Environmental context includes features associated with the systems participating in the transaction flow/routing, for example, issuer identifier, payment card number, and merchant identifier. Geographical context can include features associated with the geography of the systems participating in the transaction, for example, merchant country, terminal country, and issuer region.

In some cases, a suitable node embedding (e.g., of transaction context, environmental context, and geographical context,) at different date and time over historical transaction data records can be used to provide insight for the routing recommendation system 400.

Returning to FIGS. 3A and 3B, the routing recommendation system 360 provides the one or more predicted transaction approval systems identified using one or more of models 405. In some cases, the routing recommendation system 360 can sort the one or more predicted transaction approval systems into an ordered list, and the top recommendation can be the recommended transaction approval system. For example, the routing recommendation system 360 can get a weighted hybrid score of each transaction approval system output by the models 405 by combining the output of a collaborative filtering algorithm model and a content-based filtering algorithm model with past transaction. The weighted hybrid score can be converted into a list of tuples where the first element is its position and the second is the similarity score. The routing recommendation system 360 can create a sorted list of transaction approval systems (e.g., as represented by the tuples), wherein the list is ordered by weighted hybrid score for each transaction approval system (e.g., ordered by similarity score). A top one or more of the sorted list of transaction approval systems can thus be provided.

Accordingly, in operation, the routing recommendation system 360 can predict a transaction approval system based in part on the extracted features. The output of the routing recommendation system 360 can be the predicted transaction approval system. In some cases, the routing recommendation system 360 can output an ordered list of transaction approval systems.

As explained with respect to the example implementations of FIGS. 4A-4B, the routing recommendation system 360 may be trained on historical processing data of the primary issuer (e.g., transactions for payment cards associated with the primary issuer). This can include historical processing data for each transaction of a plurality of historical transactions. For example, the historical processing data can indicate whether the primary issuer was the authorizing transaction approval system, or whether the primary issuer failed to respond, and another system was the authorizing transaction approval system.

Advantageously, because the recommended transaction approval system is determined based on historical processing with respect to the primary issuer and features extracted from the transaction request, the authorization has an increased likelihood of being successful on a first attempt.

The following examples illustrate scenarios that may occur during a payment process.

### EXAMPLE 1

A transaction is occurring at a time and for a cardholder of a primary issuer that is predicted to be unavailable/have a network issue. Here, process 300 begins when the payment network system 350 receives (310) a transaction request. In this example, the transaction request includes transaction information, including a payment card number (****9876) and a time of the transaction (5:00 PM EST).

In response to receiving (310) the transaction request, the payment network system 350 can determine (320) a transaction approval system for the transaction.

The payment network system 350, via the extractor 355, can extract (322) features of the transaction request. In this example, the features extracted are a time of the transaction and a primary issuer identifier.

Here, the time of the transaction of 5:00 PM EST is extracted from the transaction request. In some cases, the extractor 355 can format the time of the transaction in a format compatible with the routing recommendation system 360.

Extracting (322) features from the transaction request also includes identifying a primary issuer identifier associated with the transaction request. For example, the extractor 355 may use the payment card number (****9876) included in transaction request to determine that “Issuer Blue” is the primary issuer associated with that particular payment card (e.g., by performing a look-up in a storage resource at the payment network 120). In some cases, the extractor 355 can format the primary issuer identifier in a format compatible with the routing recommendation system 360, for example, using an identification number associated with Issuer Blue.

Once the extractor 355 has extracted the features (e.g., primary issuer and the time of the transaction), the extracted features can be input into the routing recommendation system 360, as shown at flow (324).

Based on the features input to the routing recommendation system 360, in this example scenario, the recommended transaction approval system is predicted as a stand-in system on the payment network 120.

Based on the output of the recommended transaction approval system 340, the payment network system 350 sends (330) an authorization request for the transaction to the stand-in system as the first attempt instead of routing the authorization request to the primary issuer.

### EXAMPLE 2

A transaction is occurring at a time and for a cardholder of a primary issuer that is predicted to be available. Here, process 300 begins when the payment network system 350 receives (310) a transaction request. In this example, the transaction request includes transaction information, including the same payment card number (****9876) as in Example 1, and a time of the transaction (12:00 PM EST), which is different than the time of the transaction from Example 1.

In response to receiving (310) the transaction request, the payment network system 350 determines (320) a transaction approval system for the transaction.

The extractor 355 extracts (322) features of the transaction request. In this example, the features extracted are a time of the transaction and a primary issuer identifier.

Here, the time of the transaction of 12:00 PM EST is extracted from the transaction request. In some cases, the extractor 355 can format the time of the transaction in a format compatible with the routing recommendation system 360.

Extracting (322) features from the transaction request also includes identifying a primary issuer identifier associated with the transaction request. For example, the extractor 355 may use the payment card number (****9876) included in transaction request to determine that “Issuer Blue” is the primary issuer associated with that particular payment card (e.g., by performing a look-up in a storage resource at the payment network 120). In some cases, the extractor 355 can format the primary issuer identifier in a format compatible with the routing recommendation system 360, for example, using an identification number associated with Issuer Blue.

Once the extractor 355 has extracted the features (e.g., primary issuer and the time of the transaction), the extracted features can be input into the routing recommendation system 360, as shown at flow (324).

Based on the features input to the routing recommendation system 360, in this example scenario, the recommended transaction approval system is predicted as the primary issuer.

Based on the output of the recommended transaction approval system 340, the payment network system 350 sends (330) an authorization request for the transaction to the primary issuer as the first attempt.

As can be seen, the routing recommendation system 360 output a different transaction approval system in Example 1 and Example 2, despite the transaction being for the same payment card and the same primary issuer. This illustrates that a utility of the routing recommendation system 360 is to consider the historical processing of the primary issuer and the features extracted from the transaction request to output the recommended transaction approval system.

### EXAMPLE 3

A transaction is occurring at a time and for a cardholder of a primary issuer that is predicted to be unavailable/have a network issue. In addition to predictions involving features of time and primary issuer, the routing recommendation system is utilizing merchant information such as merchant location. In this example, areas of the payment network are also predicted to be down.

As with the other examples, process 300 begins when the payment network system 350 receives (310) a transaction request. In this example, the transaction request includes transaction information, including the same payment card number (****9876) as in Examples 1 and 2, a time of the transaction (12:00 PM EST), and a merchant identifier for the merchant associated with the transaction.

In response to receiving (310) the transaction request, the payment network system 350 determines (320) a transaction approval system for the transaction.

The extractor 355 extracts (322) features of the transaction request. In this example, the features extracted are a time of the transaction, a primary issuer identifier, and a merchant location.

Here, the time of the transaction of 12:00 PM EST is extracted from the transaction request. In some cases, the extractor 355 can format the time of the transaction in a format compatible with the routing recommendation system 360.

Extracting (322) features from the transaction request also includes identifying a primary issuer identifier associated with the transaction request. For example, the extractor 355 may use the payment card number (****9876) included in transaction request to determine that “Issuer Blue” is the primary issuer associated with that particular payment card (e.g., by performing a look-up in a storage resource at the payment network 120).

Extracting (322) features from the transaction request also includes identifying a merchant location using the merchant identifier. For example, the extractor 355 may use the merchant identifier included in the transaction to determine that the merchant location is the southeastern region of the United States (e.g., by performing a look-up in a storage resource at the payment network 120).

Once the extractor 355 has extracted the features (e.g., the time of the transaction, the primary issuer, and the merchant location), the extracted features can be input into the routing recommendation system 360, as shown at flow (324).

Based on the features input to the routing recommendation system 360, in this example scenario, the recommended transaction approval system is an edge device.

Based on the output of the recommended transaction approval system 340, the payment network system 350 sends (330) an authorization request for the transaction to the edge device as the first attempt instead of trying the primary issuer or a stand-in.

As illustrated by Example 3, the routing recommendation system 360 output a different transaction approval system than in Example 1 and Example 2, despite the transaction being for the same payment card and the same primary issuer.

FIG. 5 illustrates components of a computing system that may be used to implement certain methods and services described herein. Computing system may embody any of the computing systems of merchant, issuer, acquirer, and payment network. Referring to FIG. 5, system 500 may be implemented within a single computing device or distributed across multiple computing devices or sub-systems that cooperate in executing program instructions. The system 500 can include one or more blade server devices, standalone server devices, personal computers, routers, hubs, switches, bridges, firewall devices, intrusion detection devices, mainframe computers, network-attached storage devices, and other types of computing devices.

The system 500 can include a processing system 520, which may include one or more processors and/or other circuitry that retrieves and executes software 505 from storage system 515. Processing system 520 may be implemented within a single processing device but may also be distributed across multiple processing devices or sub-systems that cooperate in executing program instructions.

Examples of processing system 520 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof.

Storage system 515 can include any computer readable storage media readable by processing system 520 and capable of storing software 505 and data. Storage system 515 may be implemented as a single storage device but may also be implemented across multiple storage devices or sub-systems co-located or distributed relative to each other. Storage system 515 may include additional elements, such as a controller, capable of communicating with processing system 520.

Software 505 may be implemented in program instructions and among other functions may, when executed by system 500 in general or processing system 520 in particular, direct the system 500 or processing system 520 to operate as described herein for enabling transaction authorization request routing at a payment network. For example, software 505 may provide program instructions that implement process 300 or other operations described with respect to FIGS. 3A-3B.

Software 505 may also include additional processes, programs, or components, such as operating system software or other application software. Software 505 may also include firmware or some other form of machine-readable processing instructions executable by processing system 520.

A communication interface 525 may be included, providing communication connections and devices that allow for communication between system 500 and other computing systems.

Communication to and from client computing devices, beacons, and other computing systems (not shown) may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method, comprising:
receiving, at a payment network, a transaction request for a transaction on behalf of a cardholder, wherein the transaction request includes a time of the transaction;
determining, by the payment network, a recommended transaction approval system for authorization from a plurality of authorization-performing systems based on a primary issuer identified from the transaction request, wherein the plurality of authorization-systems comprise a stand-in system at the payment network and at least one other possible transaction approval system, wherein the recommended transaction approval system is based on historical processing with respect to the primary issuer and features extracted from the transaction request, including at least the time of the transaction; and
sending an authorization request for the transaction to the recommended transaction approval system.

2. The method of claim 1, wherein determining the recommended transaction approval system comprises:
extracting the features of the transaction request, including the time of the transaction request; and
inputting the features extracted from the transaction request to a routing recommendation system that outputs the recommended transaction approval system.

3. The method of claim 2, further comprising:
based at least in part on the output of the recommended transaction approval system, generating an ordered list of transaction approval systems for the authorization request, wherein the recommended transaction approval system is listed first.

4. The method of claim 1, wherein the recommended transaction approval system is not automatically the primary issuer.

5. The method of claim 1, further comprising:
receiving, at the payment network, a second transaction request for a second transaction on behalf of the cardholder, wherein the second transaction request includes a second time of the second transaction;
determining, by the payment network, a different recommended transaction approval system from the plurality of authorization-performing systems; and
sending a second authorization request for the second transaction to the different recommended transaction approval system, wherein the different recommended transaction approval system different than the recommended transaction approval system.

6. The method of claim 5, wherein the recommended transaction approval system is the stand-in system at the payment network and the different recommended transaction approval system is the primary issuer.

7. The method of claim 1, further comprising:
receiving, at the payment network, a third transaction request for a third transaction on behalf of the cardholder, wherein the third transaction request includes a merchant identifier;
determining, by the payment network, a second different recommended transaction approval system from the plurality of authorization-performing systems; and
sending a second authorization request for the third transaction to the second different recommended transaction approval system, wherein the second different recommended transaction approval system different than the recommended transaction approval system and the second different recommended transaction approval system.

8. The method of claim 7, further comprising:
identifying a merchant location using the merchant identifier, wherein the features extracted from the transaction request include the merchant location.

9. A payment network system, comprising:
a processing system;
one or more storage media; and
instructions stored on the one or more storage media that, when executed by the processing system, direct the payment network system to:
receive a transaction request for a transaction on behalf of a cardholder, wherein the transaction request includes a time of the transaction;
determine a recommended transaction approval system for authorization from a plurality of authorization-performing systems based on a primary issuer identified from the transaction request, wherein the plurality of authorization-performing systems comprises a stand-in system at the payment network and at least one other possible transaction approval system, wherein the recommended transaction approval system is based on historical processing with respect to the primary issuer and features extracted from the transaction request, including at least the time of the transaction; and
send an authorization request for the transaction to the recommended transaction approval system.

10. The payment network system of claim 9, wherein the instructions to determine the recommended transaction approval system direct the payment network system to:
extract the features of the transaction request, including the time of the transaction request; and
input the features extracted from the transaction request to a routing recommendation system that outputs the recommended transaction approval system.

11. The payment network system of claim 10, wherein the instructions further direct the payment network system to:
based at least in part on the output of the recommended transaction approval system, generate an ordered list of transaction approval systems for the authorization request, wherein the recommended transaction approval system is listed first.

12. The payment network system of claim 9, wherein the recommended transaction approval system is not automatically the primary issuer.

13. The payment network system of claim 9, wherein the instructions further direct the payment network system to:
receive a second transaction request for a second transaction on behalf of the cardholder, wherein the second transaction request includes a second time of the second transaction;
determine a different recommended transaction approval system from the plurality of authorization-performing systems; and
send a second authorization request for the second transaction to the different recommended transaction approval system, wherein the different recommended transaction approval system different than the recommended transaction approval system.

14. The payment network system of claim 13, wherein the recommended transaction approval system is the stand-in system at a payment network and the different recommended transaction approval system is the primary issuer.

15. A computer readable storage medium having instructions of payment network system stored thereon that when executed by a computing system, direct the computing system to at least:
receive a transaction request for a transaction on behalf of a cardholder, wherein the transaction request includes a time of the transaction;
determine a recommended transaction approval system for authorization from a plurality of authorization-performing systems based on a primary issuer identified from the transaction request, wherein the plurality of authorization-performing systems comprises a stand-in system at the payment network and at least one other possible transaction approval system, wherein the recommended transaction approval system is based on historical processing with respect to the primary issuer and features extracted from the transaction request, including at least the time of the transaction; and
send an authorization request for the transaction to the recommended transaction approval system.

16. The computer readable storage medium of claim 15, wherein the instructions to determine the recommended transaction approval system direct the computing system to:
extract the features of the transaction request, including the time of the transaction request; and
input the features extracted from the transaction request to a routing recommendation system that outputs the recommended transaction approval system.

17. The computer readable storage medium of claim 16, wherein the instructions further direct the computing system to:
based at least in part on the output of the recommended transaction approval system, generate an ordered list of transaction approval systems for the authorization request, wherein the recommended transaction approval system is listed first.

18. The computer readable storage medium of claim 15, wherein the recommended transaction approval system is not automatically the primary issuer.

19. The computer readable storage medium of claim 15, wherein the instructions further direct the computing system to:
receive a second transaction request for a second transaction on behalf of the cardholder, wherein the second transaction request includes a second time of the second transaction;
determine a different recommended transaction approval system from the plurality of authorization-performing systems; and
send a second authorization request for the second transaction to the different recommended transaction approval system, wherein the different recommended transaction approval system different than the recommended transaction approval system.

20. The computer readable storage medium of claim 19, wherein the recommended transaction approval system is the stand-in system at a payment network and the different recommended transaction approval system is the primary issuer.
